(19) United States
(12) Patent Application Publication
(10) Pub. No.: US 2025/0377451 A1
(43) Pub. Date: Dec. 11, 2025

(54) AN AIRCRAFT SURVEILLANCE SYSTEM

(71) Applicant: Johnson Controls Tyco IP Holdings LLP, Milwaukee, WI (US)

(72) Inventor: Nicholas J.F. LATHAM, Neston, Cheshire (GB)

(21) Appl. No.: 18/878,605

(22) PCT Filed: Jun. 14, 2023
(86) PCT No.: PCT/US2023/025232

§ 371 Date: Dec. 23, 2024

Related U.S. Application Data
(60) Provisional application No. 63/357,328, filed on Jun. 30, 2022.

(51) Int. Cl. G01S 13/88; G01S 7/06; G01S 13/86; G06V 20/17; G06V 20/52

(52) U.S. Cl. CPC G01S 13/886; G01S 7/06; G01S 13/867; G06V 20/17; G06V 20/52

(57) ABSTRACT

The present disclosure discloses an aircraft surveillance system. The system includes one or more radar sensors, one or more cameras, and one or more controllers. The radar sensors scan an area proximal to an aircraft and provide first data corresponding to scanning of the area. The cameras capture visuals of the area and provide second data corresponding to captured visuals. The controllers communicate with the radar sensors and cameras to receive the first data from one or more radar sensors and the second data from one or more cameras. The controllers further analyze the first data and the second data to identify presence of one or more undesirable objects proximal to the aircraft and provide a notification upon detection of the undesirable objects.

### CROSS-REFERENCE TO RELATED APPLICATION(S)

This application claims the benefit of priority to U.S. Provisional Application Ser. No. 63/357,328, entitled “AN AIRCRAFT SURVEILLANCE SYSTEM” and filed on Jun. 30, 2022,which is incorporated by reference herein in the entirety.

### BACKGROUND

The present disclosure relates generally to aircraft surveillance systems.

An aircraft is typically parked in an area of an airport termed as an apron. Variety of operations, such as loading, unloading, fueling, maintenance, etc., are performed on an aircraft when the aircraft is parked at the apron. Areas of the apron designated for aircraft parking are known as aircraft stands.

Once all operations on the aircraft are completed, a security check is carried out for the aircraft. Typically, a security check facility is located near the apron. An aircraft is brought near the facility for security check. After completion of the security check, the aircraft is brought back to its respective stand. Aircraft stands and apron are typically more accessible than a runway or a taxiway of an airport. To avoid any security breach post security check, a CCTV operator follows the aircraft and continuously monitors the aircraft till the aircraft is at apron area. However, aircrafts are sometimes stood at the apron for longer time periods which may lead to human errors in detecting security breach and may completely miss a security breach occurrence due to fatigue or negligence of the CCTV operator. Further, cost of an operator for monitoring aircrafts at the apron is huge which increases operational cost of airport.

Therefore, there is felt a need of a surveillance system for an aircraft that alleviates the aforementioned drawbacks of conventional surveillance techniques.

### SUMMARY

One implementation of the present disclosure is an aircraft surveillance system. The system comprises one or more radar sensors, one or more cameras, and one or more processors. The radar sensors are employed to scan an area proximal to an aircraft and provide first data corresponding to scanning of the area. Preferably, the system may include at least one first radar provided to scan a substantially upper outer surface area of the aircraft and at least one second radar sensor provided to scan a substantially lower outer surface area of the aircraft. Preferably, the first radar sensor and second radar sensor are placed proximal to front and rear ends of the aircraft respectively.

The cameras are employed to capture visuals of the area and provide second data corresponding to captured visuals of the area. Preferably, the cameras may include at least one of a high-resolution camera, a pan-tilt-zoom (PTZ) camera, a fixed camera, and an infrared camera.

The one or more processors, individually or in combination, are in communication with the radar sensors to receive the first data and with the cameras to receive the second data. In some aspects, the one or more processors receive an actuation signal from one or more data sources before initiating operation of the radar sensors and/or the cameras, or before initiating analysis of the first data and/or the second data.

Further, the one or more processors analyze the first data and the second data to identify presence of one or more undesirable objects proximal to the aircraft. In some aspects, the one or more processors detect objects in the first and second data, and identifies undesirable objects based on predetermined markers. In some aspects, the one or more processors identify the one or more undesirable objects using at least one of an image processing technique, video analytics and radar data analysis. In some aspects, the one or more processors may determine the location and distance of the one or more undesirable objects based on the first data.

The one or more processors transmit a notification upon detection of the undesirable objects, wherein the notification signal indicates a security threat. Providing the notification may include transmitting one or more notification signals to one or more user devices. The notification signals may include information related to location and distance of the one or more undesirable objects with respect to the aircraft.

In some aspects, a first radar sensor within the one or more radar sensors is configured to scan a substantially upper outer surface area of the aircraft and a second radar sensor within the one or more radar sensors is configured to scan a substantially lower outer surface area of the aircraft, and a first camera within the one or more cameras is configured to scan the substantially upper outer surface area of the aircraft and a second cameras within the one or more cameras is configured to scan the substantially lower outer surface area of the aircraft.

In some aspects, the first radar sensor and the second radar sensor are placed proximal to a front end and a rear end of the aircraft, respectively, and the first camera and the second camera are placed proximal to the front end and the rear end of the aircraft, respectively.

In some aspects, the one or more processors are further configured to analyze the first data and/or the second data to define an alarm zone around the aircraft; and display the alarm zone on a display screen.

In some aspects, the one or more processors are further configured to receive a signal indicating a completion of a security check of the aircraft; and indicate an armed state of the alarm zone by changing a visual characteristic of the alarm zone on the display screen.

In some aspects, the one or more processors are configured to analyze the first data and the second data responsive to the completion of the security check of the aircraft.

In some aspects, the one or more processors are configured to display the notification on the display screen.

In some aspects, the one or more processors are configured to display the notification including a zoomed view of the one or more undesirable objects.

In some aspects, the one or more processors are configured to display the notification including one or more visual characteristics of the one or more undesirable objects.

The present disclosure further discloses a method for monitoring an aircraft. The method includes receiving a first data from one or more radar sensors corresponding to scanning of an area proximal to an aircraft and a second data from one or more cameras corresponding to captured visuals of the area, analyzing the first data and the second data to identify presence of one or more undesirable objects proximal to the aircraft, providing a notification upon detection of the undesirable objects, wherein the notification signal indicates a security threat.

In some aspects, the method includes determining location and distance of the one or more undesirable objects based on the first data.

In some further aspects, a system includes one or more processors; and one or more memories each communicatively coupled with at least one of the one or more processors and each storing all or some portion of instructions that, when executed by the one or more processors, cause the one or more processors, individually or in any combination, to receive first data from one or more radar sensors configured to scan an area proximal to an aircraft and second data from one or more cameras configured to capture visuals of the area; analyze the first data and the second data to identify presence of one or more undesirable objects proximal to the aircraft; and transmit one or more notification signals to a user device upon detection of the one or more undesirable objects, wherein the one or more notification signals indicate a security threat.

Those skilled in the art will appreciate that the summary is illustrative only and is not intended to be in any way limiting. Other aspects, inventive features, and advantages of the devices and/or processes described herein, will become apparent in the detailed description set forth herein and taken in conjunction with the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a perspective view schematic drawing of a building with a security system, according to some aspects of the present disclosure.

FIG. 2 is a block diagram of building security systems for multiple buildings communicating with a cloud based security system, according to some aspects of the present disclosure.

FIG. 3 is a schematic diagram of an aircraft surveillance system illustrating placement of radar sensors and cameras, according to some aspects of the present disclosure.

FIG. 4 is a schematic diagram of fields of view of a pair of radar sensors in the aircraft surveillance system of FIG. 3, according to some aspects of the present disclosure.

FIG. 5 is a schematic diagram of fields of view of a pair of cameras in the aircraft surveillance system of FIG. 3, according to some aspects of the present disclosure.

FIG. 6 is a schematic diagram of a side view of the aircraft surveillance system of FIG. 3, according to some aspects of the present disclosure.

FIG. 7 is a schematic diagram of a display screen presented in the aircraft surveillance system of FIG. 3, according to some aspects of the present disclosure.

FIG. 8 is a block diagram of the aircraft surveillance system, according to some aspects of the present disclosure.

FIG. 9 is a flowchart illustrating method steps for determining a security threat to an aircraft, according to some aspects of the present disclosure.

FIG. 10 is a flowchart illustrating method steps for displaying an alarm zone on a display screen, according to some aspects of the present disclosure

### DETAILED DESCRIPTION

One or more specific aspects will be described below. In an effort to provide a concise description of these aspects, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment/aspect” or “an embodiment/aspect” of the present disclosure are not intended to be interpreted as excluding the existence of additional embodiments/aspects that also incorporate the recited features.

### Building Security System

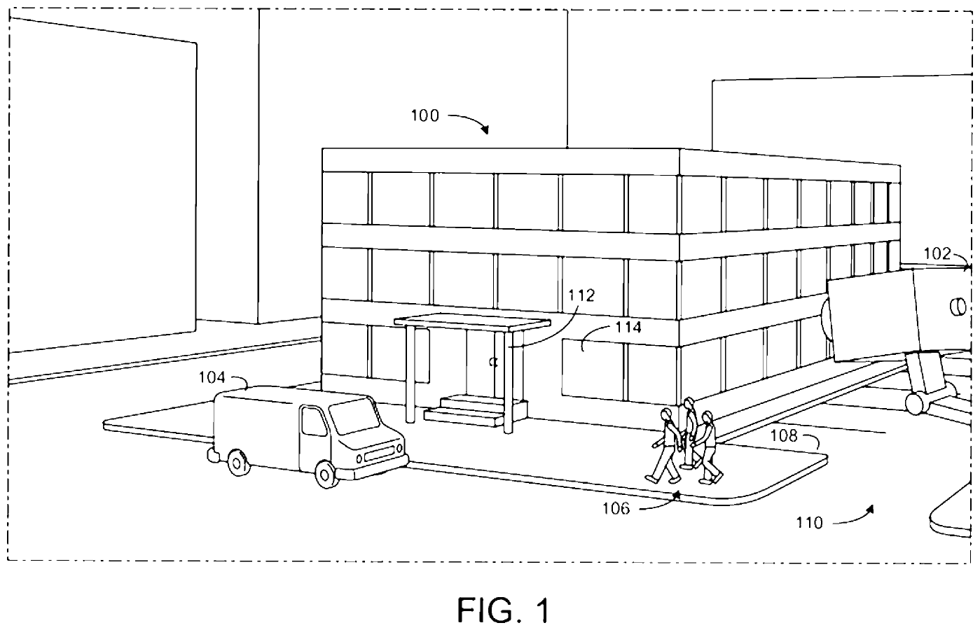

Referring now to FIG. 1, a building 100 with a security camera 102 and a parking lot 110 is shown, according to an example aspect. The building 100 is a multi-story commercial building surrounded by, or near, the parking lot 110 but can be any type of building in some aspects. The building 100 may be a school, a hospital, a store, a place of business, a residence, a hotel, an office building, an apartment complex, etc. The building 100 can be associated with the parking lot 110. In some aspects, the building 100 is associated with airports. For example, the building 100 can be a security check facility at an airport. The building 100 can be placed at any suitable location at the airport. In one aspect, the building 100 is situated near an apron area of an airport.

Both the building 100 and the parking lot 110 are at least partially in the field of view of the security camera 102. In some aspects, multiple security cameras 102 may be used to capture the entire building 100 and parking lot 110 not in (or in to create multiple angles of overlapping or the same field of view) the field of view of a single security camera 102. The parking lot 110 can be used by one or more vehicles 104 where the vehicles 104 can be either stationary or moving (e.g., busses, cars, trucks, delivery vehicles). The building 100 and parking lot 110 can be further used by one or more pedestrians 106 who can traverse the parking lot 110 and/or enter and/or exit the building 100. The building 100 may be further surrounded, or partially surrounded, by a sidewalk 108 to facilitate the foot traffic of one or more pedestrians 106, facilitate deliveries, etc. In other aspects, the building 100 may be one of many buildings belonging to a single industrial park, shopping mall, or commercial park having a common parking lot and security camera 102. In another aspect, the building 100 may be a residential building or multiple residential buildings that share a common roadway or parking lot.

The building 100 is shown to include a door 112 and multiple windows 114. An access control system can be implemented within the building 100 to secure these potential entrance ways of the building 100. For example, badge readers can be positioned outside the door 112 to restrict access to the building 100. The pedestrians 106 can each be associated with access badges that they can utilize with the access control system to gain access to the building 100 through the door 112. Furthermore, other interior doors within the building 100 can include access readers. In some aspects, the doors are secured through biometric information, e.g., facial recognition, fingerprint scanners, etc. The access control system can generate events, e.g., an indication that a particular user or particular badge has interacted with the door. Furthermore, if the door 112 is forced open, the access control system, via door sensor, can detect the door forced open (DFO) event.

The windows 114 can be secured by the access control system via burglar alarm sensors. These sensors can be configured to measure vibrations associated with the window 114. If vibration patterns or levels of vibrations are sensed by the sensors of the window 114, a burglar alarm can be generated by the access control system for the window 114.

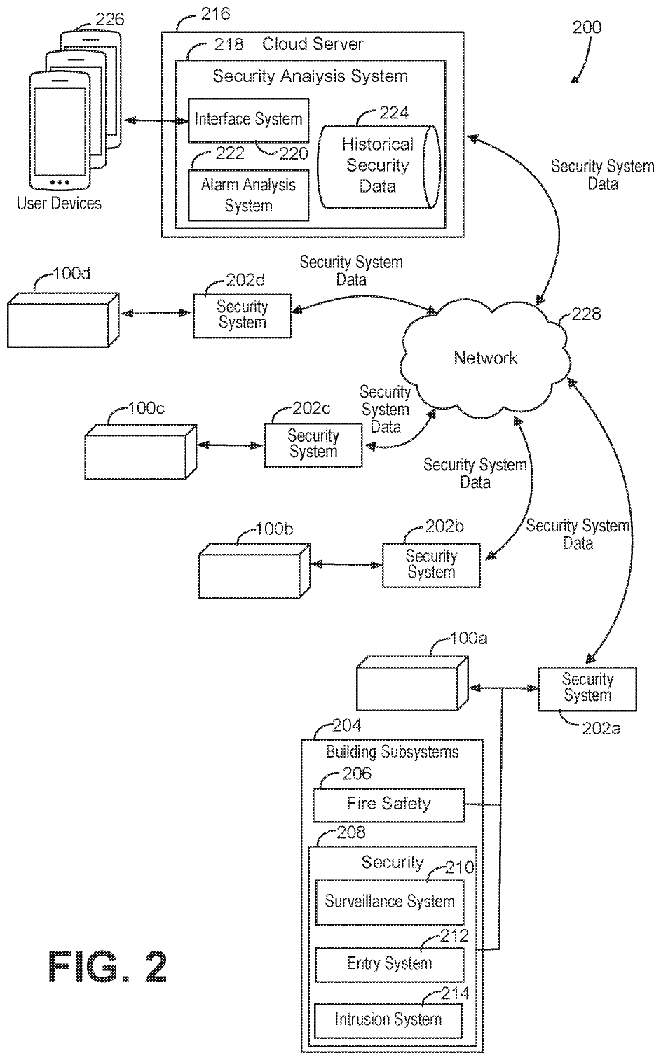

Referring now to FIG. 2, a security system 200 is shown for multiple buildings, according to an example aspect. The security system 200 is shown to include buildings 100a-100d. Each of buildings 100a-100d is shown to be associated with a security system 202a-202d. The buildings 100a-100d may be the same as and/or similar to building 100 as described with reference to FIG. 1. The security systems 202a-202d may be one or more controllers, servers, and/or computers located in a security panel or part of a central computing system for a building.

The security systems 202a-202d may communicate with, or may include, various security sensors and/or actuators, building subsystems 204. For example, fire safety subsystems 206 may include various smoke sensors and alarm devices, carbon monoxide sensors, alarm devices, etc. Security subsystems 208 are shown to include a surveillance system 210, an entry system 212, and an intrusion system 214. The surveillance system 210 may include various video cameras, still image cameras, and image and/or video processing systems for monitoring various rooms, hallways, parking lots, the exterior of a building, the roof of the building, etc. The entry system 212 can include one or more systems configured to allow users to enter and exit the building (e.g., door sensors, turnstiles, gated entries, badge systems, etc.) The intrusion system 214 may include one or more sensors configured to identify whether a window or door has been forced open. The intrusion system 214 can include a keypad module for arming and/or disarming a security system and various motion sensors (e.g., IR, PIR, etc.) configured to detect motion in various zones of the building 100a.

Each of buildings 100a-100d may be located in various cities, states, and/or countries across the world. There may be any number of buildings 100a-100d. The buildings 100a-100d may be owned and operated by one or more entities. For example, a grocery store entity may own and operate buildings 100a-100d in a particular geographic state. The security systems 202a-202d may record data from the building subsystems 204 and communicate collected security system data to the cloud server 216 via network 228.

In some aspects, the network 228 communicatively couples the devices, systems, and servers of the system 200. In some aspects, the network 228 is at least one of and/or a combination of a Wi-Fi network, a wired Ethernet network, a ZigBee network, a Bluetooth network, and/or any other wireless network. The network 228 may be a local area network and/or a wide area network (e.g., the Internet, a building WAN, etc.) and may use a variety of communications protocols (e.g., BACnet, IP, LON, etc.). The network 228 may include routers, modems, and/or network switches. The network 228 may be a combination of wired and wireless networks.

The cloud server 216 is shown to include a security analysis system 218 that receives the security system data from the security systems 202a-202d of the buildings 100a-100d. The cloud server 216 may include one or more processing circuits (e.g., memory devices, processors, databases) configured to perform the various functionalities described herein. The cloud server 216 may be a private server. In some aspects, the cloud server 216 is implemented by a cloud system, examples of which include AMAZON WEB SERVICES® (AWS) and MICROSOFT AZURE®.

A processing circuit of the cloud server 216 can include one or more processors and memory devices. The processor can be a general purpose or specific purpose processor, an application specific integrated circuit (ASIC), one or more field programmable gate arrays (FPGAs), a group of processing components, or other suitable processing components. The processor may be configured to execute computer code and/or instructions stored in a memory or received from other computer readable media (e.g., CDROM, network storage, a remote server, etc.).

The memory can include one or more devices (e.g., memory units, memory devices, storage devices, etc.) for storing data and/or computer code for completing and/or facilitating the various processes described in the present disclosure. The memory can include random access memory (RAM), read-only memory (ROM), hard drive storage, temporary storage, non-volatile memory, flash memory, optical memory, or any other suitable memory for storing software objects and/or computer instructions. The memory can include database components, object code components, script components, or any other type of information structure for supporting the various activities and information structures described in the present disclosure. The memory can be communicably connected to the processor via the processing circuit and can include computer code for executing (e.g., by the processor) one or more processes described herein.

In some aspects, the cloud server 216 can be located on premises within one of the buildings 100a-100d. For example, a user may wish that their security, fire, or HVAC data remain confidential and have a lower risk of being compromised. In such an instance, the cloud server 216 may be located on-premises instead of within an off-premises cloud platform.

The security analysis system 218 may implement an interface system 220, an alarm analysis system 222, and a database storing historical security data 224, security system data collected from the security systems 202a-202d. The interface system 220 may provide various interfaces of user devices 226 for monitoring and/or controlling the security systems 202a-202d of the buildings 100a-100d. The interfaces may include various maps, alarm information, maintenance ordering systems, etc. The historical security data 224 can be aggregated security alarm and/or event data collected via the network 228 from the buildings 100a-100d. The alarm analysis system 222 can be configured to analyze the aggregated data to identify insights, detect alarms, reduce false alarms, etc. The analysis results of the alarm analysis system 222 can be provided to a user via the interface system 220. In some aspects, the results of the analysis performed by the alarm analysis system 222 are provided as control actions to the security systems 202a-202d via the network 228.

### Aircraft Surveillance System

The present disclosure further discloses a ground-based aircraft surveillance system (hereinafter also referred as system). The system includes one or more radar sensors and one or more cameras. The radar sensors scan an area proximal to an aircraft and provide a first data corresponding to scanning of the area. The cameras capture visuals of the area and provide a second data corresponding to captured visuals. The cameras may capture images or a video of the area. The system further includes a controller that receives the first data and second data. The controller is configured to identify undesirable objects near the aircraft. The undesirable objects can be a person, vehicle, or any other object that can impose a security threat to the aircraft. The controller transmits one or more notification signals upon detection of the undesirable objects. The notification signal indicates a security threat.

In some aspects, a first cumulative area is covered by the combination of the radar sensors, and a second cumulative area is covered by the radar sensors. In these aspects, the surveilled area proximal to the aircraft falls within an intersection of the first cumulative area and the second cumulative area. In some aspects, each one of the radar sensors and the cameras covers a portion of the surveilled area proximal to the aircraft.

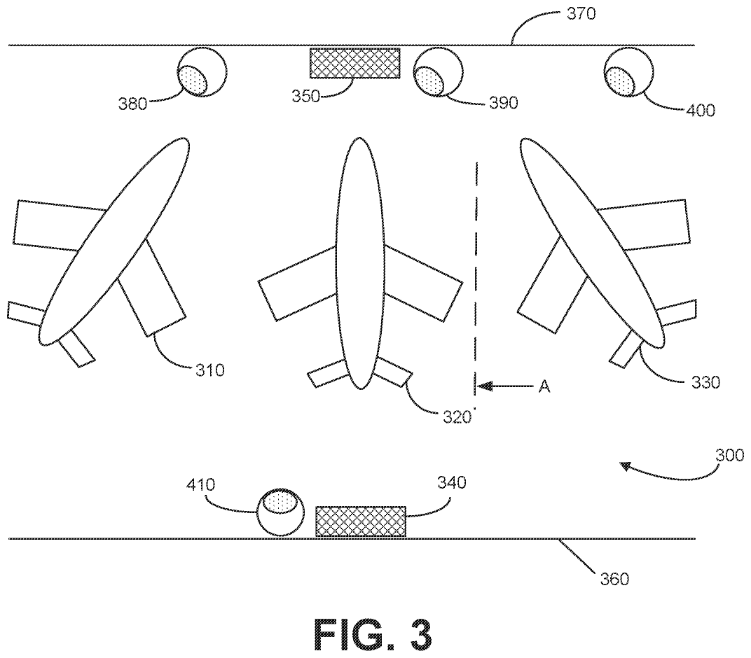

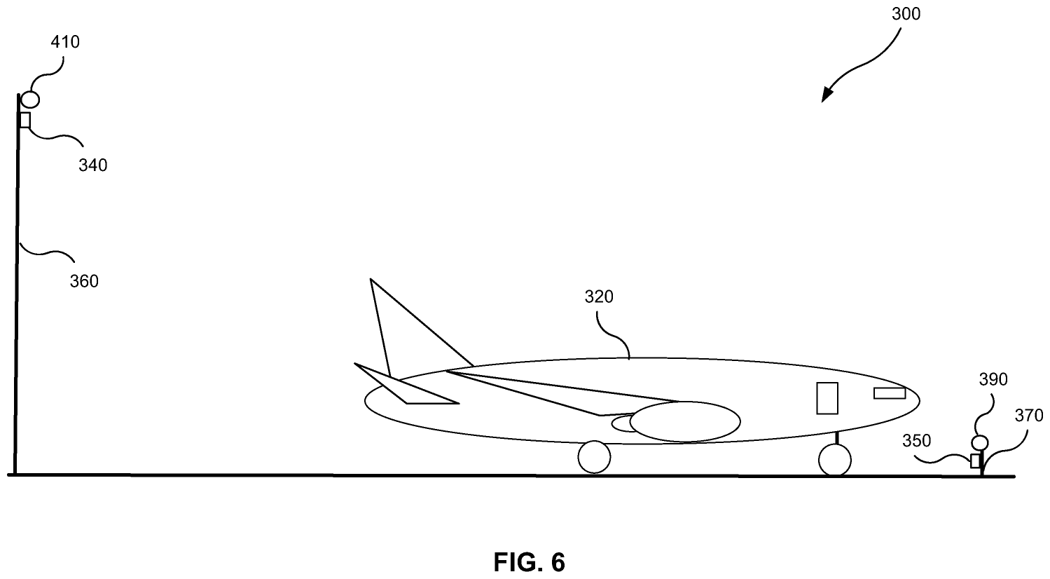

The system is now described in detail with reference to accompanying FIGS. 3-10.

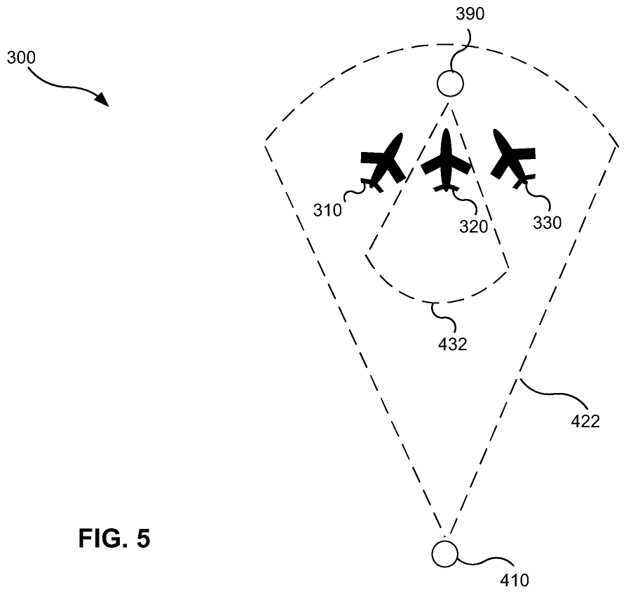

Referring to FIG. 3, a top view of an apron 300 is shown. A side view of the apron 300 as viewed in a direction A (indicated in FIG. 3) is also illustrated in FIG. 5. The apron 300 is an area of an airport where aircrafts are parked for various activities such as maintenance, loading, unloading, etc. The apron 300 includes a plurality of aircraft stands (not specifically shown in figures) for parking aircrafts. In FIG. 3, aircrafts 310, 320, 330 are shown to be parked at the apron 300. It is to be noted that number of aircrafts shown in FIG. 3 are for explanation purpose only. Any number of aircrafts can be parked at the apron 300 depending upon total area of the apron 300 and size of aircrafts. Typically, guidelines such as apron markings are provided at the apron 300 for facilitating parking of the aircrafts at respective stands.

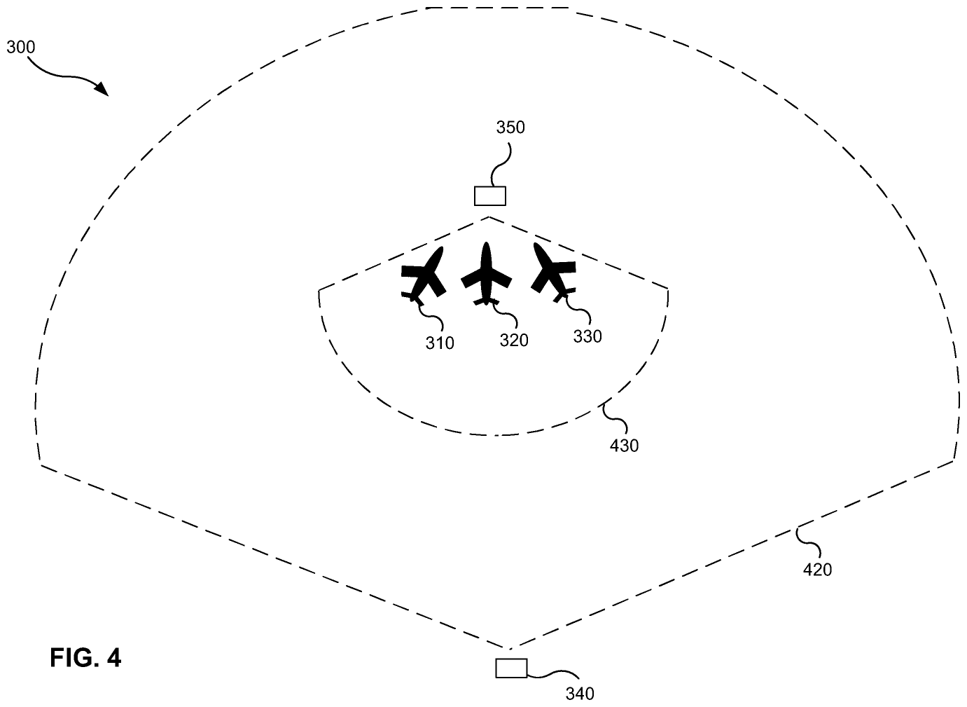

Still referring to FIG. 3, a pair of radar sensors are provided for scanning an area proximal to aircrafts 310-330 and aircrafts 310-330. The radar sensors transmit first data corresponding to scanning of the area. In some aspects, the pair of radar sensors include a first radar sensor 340 and a second radar sensor 350. Preferably, the first radar sensor 340 is provided to have a first field of view 420 (see FIG. 4) to scan a substantially upper outer surface of aircrafts 310-330, whereas the second radar sensor 350 is provided to have a second field of view 430 (see FIG. 4) to scan a substantially lower outer surface of aircrafts 310-330. Although FIG. 3 illustrates two radar sensors for scanning three aircrafts, separate one or more radar sensors may be provided for scanning outer surface area of each aircraft in some other aspects. It is to be noted that the number of radar sensors for each aircraft may vary as per various factors such as size of aircraft, location of aircraft parking, orientation of aircraft, etc. In some aspects, a single radar sensor may be provided to scan outer surface area of all aircrafts parked at the apron. In some aspects, separate radar sensor may be provided for each aircraft. In some other aspects, more than one radar sensor may be provided for scanning all aircrafts. In some other aspects, separate set of multiple radar sensors can be provided to scan each aircraft. The fields of view of the radar sensors may meet or may at least partially overlap in order to provide a complete view of each aircraft (see FIG. 4).

The radar sensors 340, 350 are strategically placed such that the radar sensors 340, 350 can scan maximum outer surface area of each aircraft. In some aspects, the first radar sensor 340 and the second radar sensor 350 are placed proximal to a front end and a rear end of aircrafts 310-330 respectively. In some aspects, the first radar sensor 340 is placed proximal to a first boundary 360 of the apron 300, whereas the second radar sensor 350 is placed proximal to a second boundary 370 of the apron. Placement of the radar sensors 340, 350 near boundaries of the apron 300 minimizes interference of radar sensor's mounting assembly with area of apron 300 and allows maximum apron area accessible for aircrafts. Although the present disclosure is described with reference to two radar sensors placed near boundaries of the apron, the surveillance system is not limited to two radars and can have any number of radar sensors placed at any suitable location.

Still referring to FIG. 3, one or more cameras are provided to capture visuals of an area proximal to aircrafts 310-330 and aircrafts 310-330. The cameras transmit second data corresponding to captured visuals of one or more aircrafts 310-330. The number of cameras can be determined based on various factors such as size of aircraft, location of aircraft parking, orientation of aircraft, etc. For example, a first camera 380, a second camera 390, and a third camera 400 are arranged proximal to a nose of aircrafts 310, 320, 330 respectively. Preferably, the cameras 380, 390, 400 can be arranged near or at the second boundary 370 and may have a field of view covering a lower elevation area proximal to a nose of an aircraft (see FIG. 5, a field of view 432 of the second camera 390). In some other aspects, a single camera can be employed to capture visuals of the aircrafts 310-330. In some aspects, multiple dedicated cameras can be placed for capturing visuals of each aircraft. Further, a fourth camera 410 can be arranged near tail ends of the aircrafts 310, 320, 330. Preferably, the fourth camera 410 can be arranged near or at the first boundary 360 and may have a field of view 422 covering a higher elevation area proximal to a tail of one or more aircrafts (see FIG. 5).

The cameras 380-410 can include various video cameras, still image cameras, and image and/or video processing systems. In some aspects, one or more cameras 380-410 can be a high-resolution camera, a pan-tilt-zoom (PTZ) camera, a fixed camera, and an infrared camera. For example, the first camera 380, second camera 390, and third camera 400 are PTZ cameras, whereas the fourth camera 410 is a high-resolution camera. In alternative aspects, the cameras 380-410 can be placed at any suitable location and can vary in numbers and types based on application requirement.

The location of the cameras and the sensors may be determined such that maximum components of an aircraft to be monitored are covered by the cameras and sensors.

In some aspects, the camera and the radar sensor can be accommodated in a single unit. For example, a PTZ camera and a radar sensor can be accommodated in single unit such as an all-in-one radar PTZ camera. In some other aspects, a PTZ camera can be linked to a radar sensor.

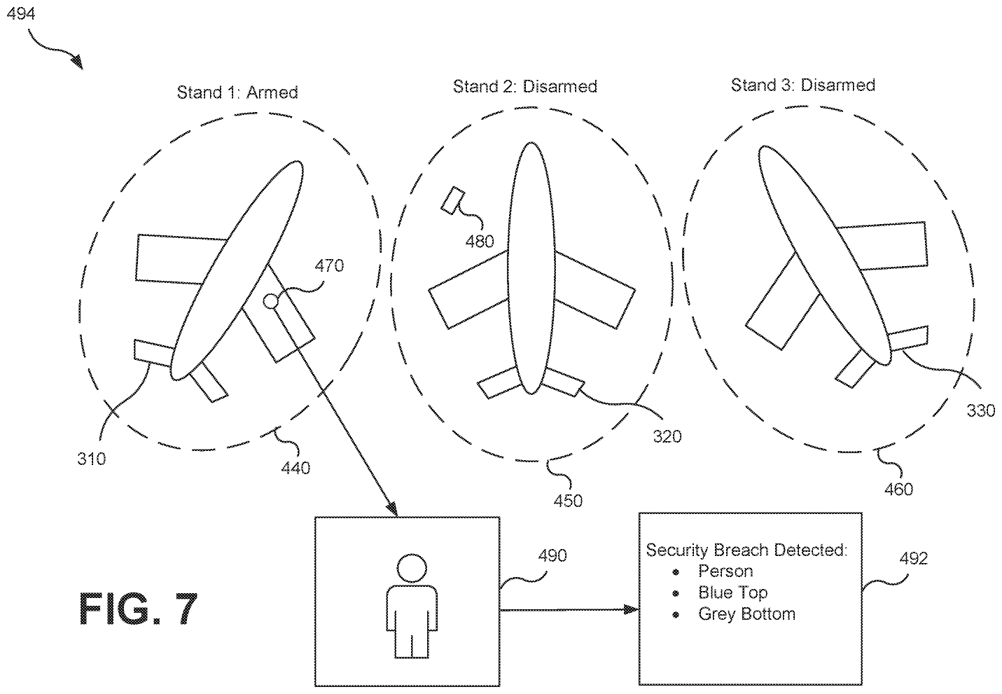

Referring to FIG. 7, some present aspects provide a display screen 494 that displays monitoring information and/or alarms to one or more operators of the aircraft surveillance system. The display screen 494 may provide monitoring/alarm information related to a vicinity of the stands where the aircrafts 310, 320, 330 are parked. The display screen 494 may be used for surveillance of an aircraft during a final security check conducted after a service such as loading, unloading, fueling, maintenance, etc. is performed for an aircraft that is parked in the apron 300. In an aspect, for example, once all of the duties are complete for an aircraft, the following process may be performed. First, the staff conduct a pre-search of the aircraft. Then, the search team carry out the checks whilst the aircraft is parked at an aircraft stand in the apron 300. Then, the security team radios the control room to “arm” a monitoring area defined around the aircraft, and in order to keep the area sterile, the area is monitored via a combination of radar sensors and cameras in the aircraft surveillance system. For example, in an aspect, based on information collected by the cameras and/or the radar sensors in the aircraft surveillance system, a first stand alarm zone 440 may be defined around the first aircraft 310 and displayed on the display screen 494, a second stand alarm zone 450 may be defined around the second aircraft 320 and displayed on the display screen 494, and a third stand alarm zone 460 may be defined around the third aircraft 330 and displayed on the display screen 494. In various aspects, the stand alarm zones 440, 450, 460 may be defined to have an oval, rectangular, or other shape.

In an aspect, a combination of radar sensors and cameras in the aircraft surveillance system may be used to detect objects/persons in a stand alarm zone around an aircraft, and if needed, a corresponding alarm may be presented to the operators of the aircraft surveillance system via the display screen 494. For example, in an aspect, the first stand alarm zone 440 around the first aircraft 310 may be armed once the first aircraft 310 is checked. This may be manually performed by an operator following a signal from one or more mobile guards/personnel that are personally present in the apron 300 and are in charge of the security of the first aircraft 310. In an aspect, the display screen 494 may change to indicate the armed state of the first stand alarm zone 440, e.g., may change a background color of the first stand alarm zone 440 from green to red. The radar and AI analytics from the static camera events may then become active once triggered, and information provided by the cameras and radar sensors is used to automatically present any alarm or other information on the display screen 494 once the first stand alarm zone 440 is manually armed.

In an aspect, for example, upon an object entering the first stand alarm zone 440, the AI may classify the alarm depending on whether the object is a human 470, a vehicle 480, a drone (not shown), etc. In an aspect, for example, the second stand alarm zone 450 is not armed, and therefore detecting the vehicle 480 in the second stand alarm zone 450 does not initiate an alarm. However, the first stand alarm zone 440 is armed, and therefore detecting the human 470 in the first stand alarm zone 440 initiates an alarm indicating a breach detected by radar and camera AI. In some aspects, the cameras may track one or more of the detected objects.

In an aspect, when an alert is initiated, corresponding annunciation may be provided via the display screen 494, e.g., via maps, video pop-ups, etc. For example, upon detecting the human 470 in the first stand alarm zone 440 which is armed, a first pop-up display area 490 may be provided on the display screen 494 to provide detailed (zoomed-in) imagery of the human 470 as captured by the cameras, and a second pop-up display area 492 may be provided on the display screen 494 to provide textual details and visual identifiers of the human 470, such as “Security Breach Detected: Person, Blue Top, Grey Bottom.” The area of breach may be determined and documented through a system workflow for audit purposes. Once the operators receive the alarm event, a standard operating procedure (SOP) process is followed.

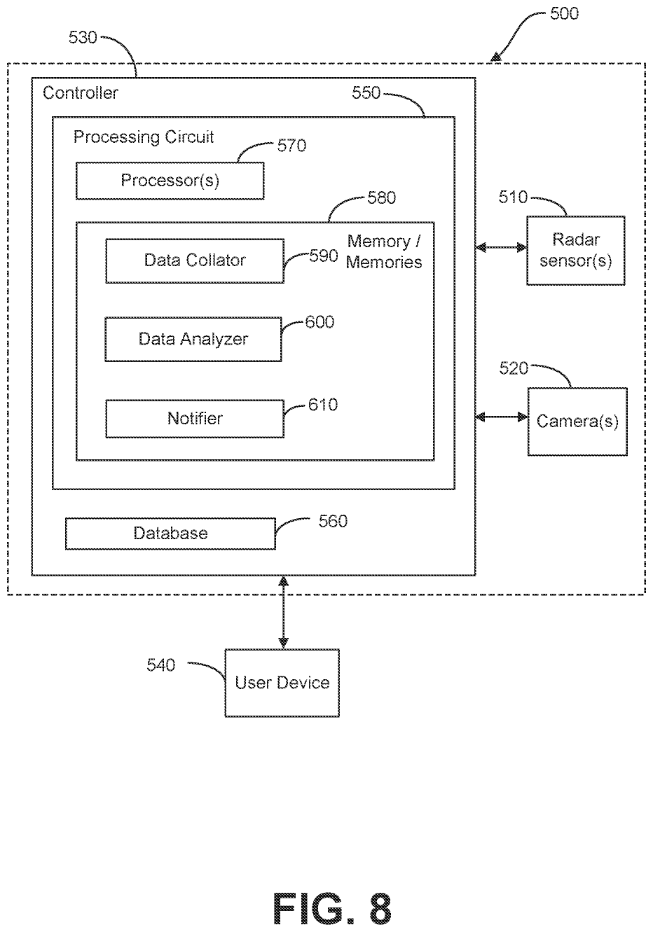

Referring to FIG. 8, a system 500 is shown to include one or more radar sensors 510, one or more cameras 520, and a controller 530. The radar sensors 510 can be the radar sensors 340, 350. The cameras 520 can be the cameras 380-410. The radar sensors 510 and the cameras 520 can be in wired or wireless communication with the controller 530. In some aspects, the radar sensors 510 and the cameras 520 communicate with the controller 530 via a network. The network is at least one of and/or a combination of a Wi-Fi network, a wired Ethernet network, a ZigBee network, a Bluetooth network, and/or any other wireless network. The network may be a local area network and/or a wide area network (e.g., the Internet, a building WAN, etc.) and may use a variety of communications protocols (e.g., BACnet, IP, LON, etc.). The network may include routers, modems, and/or network switches. The network may be a combination of wired and wireless networks.

The controller 530 may be provided at a security check facility of an airport. In some other aspects, the controller 530 may be provided in a cloud-based server (not specifically shown in figures). The cloud server can be located on premises within the security check facility. For example, a user may wish that their security data remain confidential and have a lower risk of being compromised. In such an instance, the cloud server may be located on-premises instead of within an off-premises cloud platform. In some other aspects, the cloud server may be located away from the security check facility.

In some other aspects, the controller 530 is communicatively coupled to a user device 540. The user device 540 may be provided in the security check facility. The controller 530 may be in wired or wireless communication with the user device 540. The user device 540 facilitates a user to interact with the controller 530. The interaction can be to provide input data, make changes in data, security threat data, live streaming of data feed by cameras and/or radar sensors, etc. The user device 540 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with system 500 and its devices. The user device 540 can be a computer workstation, a client terminal, a remote or local interface, or any other type of user interface device. The user device 540 can be a stationary terminal or a mobile device. For example, the user device 540 can be a desktop computer, a computer server with a user interface, a laptop computer, a tablet, a smartphone, a PDA, or any other type of mobile or non-mobile device.

The controller 530 includes a processing circuit 550 and a database 560. Various parameter values related to detection of security threat or information related to threat detection may be stored in the database 560. The parameters are typically determined on the basis of type and operating condition of airport and/or aircrafts for which the system 500 is employed. In some aspects, the predetermined parameters stored in the database 560 are editable, and a user can edit the same via the user device 540.

The processing circuit 550 includes one or more processors 570 and one or more memories 580. The one or more processors 570 can be implemented as a general-purpose processor, an application specific integrated circuit (ASIC), one or more field programmable gate arrays (FPGAs), a group of processing components, or other suitable electronic processing components.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

The one or more memories 580 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present disclosure. Memory 580 can be or include volatile memory or non-volatile memory. The one or more memories 580 can include database components, object code components, script components, or any other type of information structure for supporting the various activities and information structures described in the present application. According to some aspects, the one or more memories 580 are communicably connected to the one or more processors 570 via processing circuit 550 and include computer code for executing (e.g., by processing circuit 550 and/or the one or more processors 570) one or more processes described herein.

The controller 530 is in communication with the radar sensors 510 and the cameras 520 to control operation thereof. The one or more memories 580 may include a device operator provided to control operation of the sensors and cameras. The device operator transmits control signals to actuate and deactivate the cameras and sensors. Further, the device operator may transmit control signal to alter position of the sensors and/or the cameras. In some aspects, the controller 530 may receive instructions from a user through the user device 540 to operate the radar sensors 510 and the cameras 520. For example, a user may provide instructions to the controller 530 to pan, zoom, and/or tilt one or more of the cameras 520. In some other aspects, the controller 530 may operate the radar sensors 510 and the cameras 520 based on predetermined logic. For example, the controller 530 may transmit control signals to turn one or more of the cameras 520 by a predetermined angle after predetermined time intervals. Similarly, the controller 530 may provide control signals to zoom or pan the camera after a predetermined time interval. In some other aspects, the controller 530 may adjust the radar sensors 510 and the cameras 520 so that sufficient view of an aircraft to be monitored is obtained, for example, by adjusting the fields of view 420, 430 of the radar sensors 340, 350 in FIG. 4 and/or by adjusting the fields of view 422, 432 of the cameras 410 and 390 in FIG. 5. In some aspects, the top view of the fields of view 420, 430 of the radar sensors 340, 350 are at least partially overlapping. In some aspects, the top view of the fields of view 422, 432 of the cameras 410 and 390 are at least partially overlapping. The controller 530 may employ image processing technique or video analytics to identify whether sufficient view of an aircraft is captured by the radar sensors 510 and/or the cameras 520.

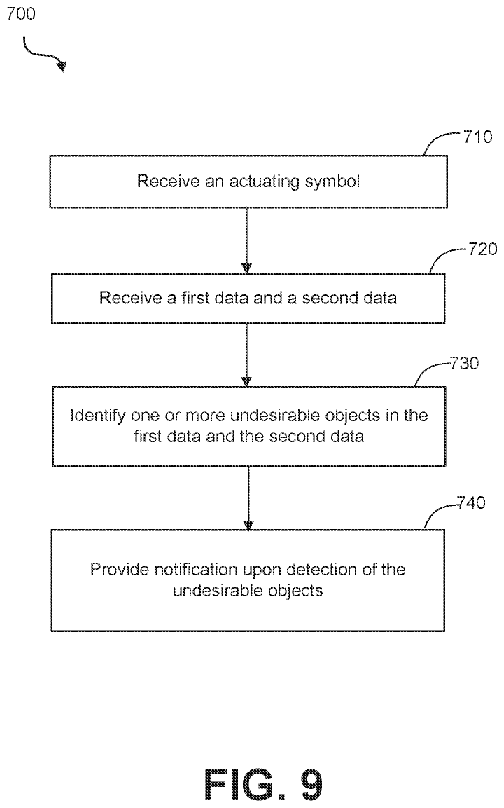

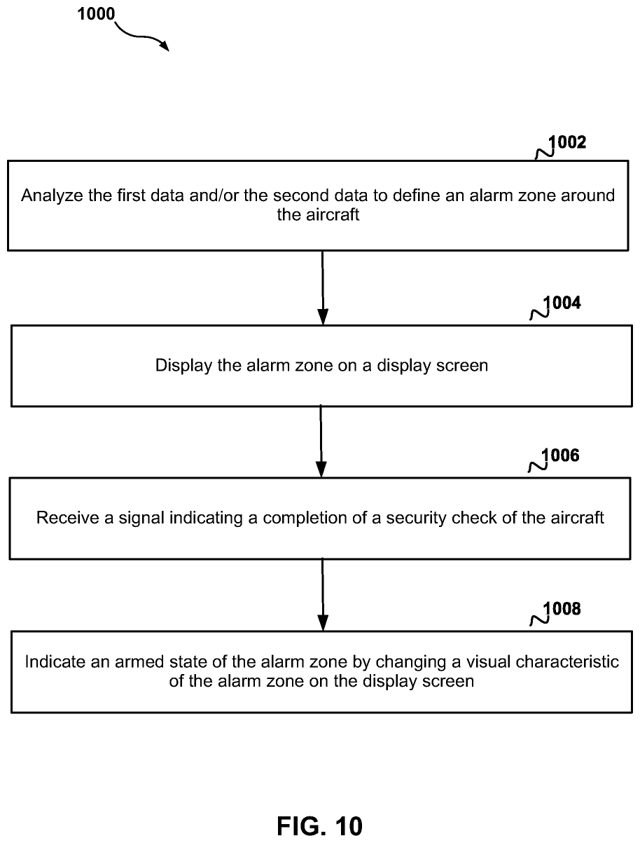

FIGS. 9 and 10 are flow charts illustrating method 700 and 1000 for detecting a security threat to an aircraft. Specifically, each one of, or any combination of, the methods 700 and 1000, may represent an algorithm performed by the controller 530, the one or more processors 570, and/or the one or more memories 580 of the system 500. Although the following description of the methods 700 and 1000 is described in a particular order, it should be noted that the methods 700 and 1000 are not limited to the depicted order; and, instead, the methods 700 and 1000 may be performed in any suitable order. As a specific example, the methods 700 and 1000 (or algorithms) will be described as being performed by the controller 530, the one or more processors 570, and/or the one or more memories 580, in accordance with the present aspects.

Referring to the method 700 in FIG. 9, at block 710, the controller 530, the one or more processors 570, and/or the one or more memories 580 receives an actuating signal. Typically, the actuation signal is transmitted to the controller 530, the one or more processors 570, and/or the one or more memories 580 through the user device 540. In some aspects, the actuation signal is transmitted upon completion of a security check of an aircraft by security personnel. After completion of the security check, it is desirable that no person, vehicle, or other such object should go near to an aircraft. Thus, the user transmits the actuation signal to the controller 530, the one or more processors 570, and/or the one or more memories 580 for initiating operation of the system 500 after completion of the security check. In some other aspects, the system 500 may continuously or intermittently monitor an aircraft without requiring an actuation signal. The intermission between two monitoring sessions of the system 500 may vary by a predetermined time period. In some aspects, the system 500 may monitor aircrafts for a particular time period of a day, a week, or a month. The system 500 may automatically monitor aircrafts based on schedule of parking of aircrafts at the apron of an airport. In this case, the system 500 initiates surveillance when aircraft is parked and stops surveillance when aircraft is moved from the apron area.

The controller 530, the one or more processors 570, and/or the one or more memories 580 actuates the radar sensors 510 and the cameras 520 upon reception of the actuation signals. In some other aspects, the radar sensors 510 and the cameras 520 can be actuated and operated by another control device. The controller 530, the one or more processors 570, and/or the one or more memories 580 establishes communication and starts accepting data from the radar sensors 510 and the cameras 520 upon reception of the actuation signals.

At block 720, the controller 530, the one or more processors 570, and/or the one or more memories 580 receives the first data corresponding scanning of an area by the radar sensors 510 and the second data corresponding to captured visuals by the cameras 520. In some aspects, the controller 530, the one or more processors 570, and/or the one or more memories 580 may request the radar sensors 510 and the cameras 520 for receiving the first data and the second data respectively. In some other aspects, the controller 530, the one or more processors 570, and/or the one or more memories 580 may continuously receive the first data and the second data once communication is established with the radar sensors 510 and the cameras 520. The one or more memories 580 include a data collator 590 configured to receive the first data and the second data. The data collator 590 further configured to collate the first data and the second data, and generate a collated data. The data collator 590 may collate the first data and second data received from particular sensors and cameras associated with an aircraft and generate collated data corresponding to that aircraft. In some aspects, the data collator 590 may collate first data and second data of all cameras and sensors deployed in the apron area and generate collated data corresponding to number of aircrafts parked in the apron area. In some aspects, the data collator 590 may clean the first and second data prior to collating the same. Cleaning the first and second data may include fixing or deleting incorrect, corrupt, duplicate, or incomplete data files within the first and second data.

At block 730, the controller 530, the one or more processors 570, and/or the one or more memories 580 identifies one or more undesirable objects in the first data and the second data. The one or more memories 580 include a data analyzer 600 that analyzes the first and second data for identifying presence of one or more undesirable objects proximal to an aircraft. The data analyzer 600 receives collated data from the data collator 590 and analyzes the collated data for identifying undesirable objects. The undesirable objects can include a person, a vehicle, a staircase, any other object predefined by a user as a security threat, etc. In some aspects, the data analyzer 600 employs at least one of an image processing technique, video analytics, and radar data analysis for identifying undesirable objects.

The data analyzer 600 may provide markers to objects identified from the first and second data. The markers are virtual markers. For example, the data analyzer 600 may provide a marker to an object identified as an aircraft. Similarly, markers can be provided to all identified objects. The system 500 may have data set having objects and corresponding markers stored in the database 560. Based on markers, the data analyzer 600 may identify objects as desirable objects or undesirable objects. A marker data having markers and their desirability may be stored in the database 560.

In some aspects, predetermined physical markers may be provided on objects that are desirable and are not security threat to an aircraft. For example, vehicles and service personnel involved in maintenance activities of an aircraft may be provided with physical markers. Such markers can be identified by the data analyzer 600. The data analyzer 600 determines such objects as desirable objects upon detection of the physical markers. If none of predetermined physical markers are identified on an object, the data analyzer 600 considers such objects as undesirable objects.

In some aspects, the data analyzer 600 determines location and distance of undesirable objects with respect to an aircraft being monitored. Preferably, the data analyzer 600 processes the first data to identify location and distance of the undesirable objects. Further, the data analyzer 600 may extract a snap of the undesirable object(s) from the second data. The data analyzer 600 may specifically mark the undesirable objects in the snap.

At block 740, the controller 530, the one or more processors 570, and/or the one or more memories 580 transmits a notification upon detection of the undesirable objects. For example, one or more notification signals may be transmitted to the user device 540 upon detection of the undesirable objects. The one or more memories 580 include a notifier 610 for transmitting one or more notification signals. The notification signal indicates a security threat. The notification signal can be in the form of an alarm indicating a presence of undesirable objects proximal to an aircraft being monitored. In some aspects, the notification signals include information related to location and distance of the one or more undesirable objects with respect to the aircraft. The notifier 610 receives location and distance of the undesirable objects from the data analyzer 600. In some aspects, the notifier 610 may transmit notification signal(s) having visuals of undesirable objects. The notifier 610 may receive snaps of the undesirable objects from the data analyzer 600. The notifier 610 may transmit a notification signal having video footage of undesirable objects. The video footage can be extracted from the second data.

Referring to the method 1000 in FIG. 10, at block 1002, the controller 530, the one or more processors 570, and/or the one or more memories 580 may analyze the first data and/or the second data to define an alarm zone around the aircraft. For example, in an aspect, based on information collected by the cameras 380, 390, 400, 410 and/or the radar sensors 340, 350 in the aircraft surveillance system, a first stand alarm zone 440 may be defined around the first aircraft 310, a second stand alarm zone 450 may be defined around the second aircraft 320, and a third stand alarm zone 460 may be defined around the third aircraft 330. In various aspects, the stand alarm zones 440, 450, 460 may be defined to have an oval, rectangular (box), or other shape.

At block 1004, the controller 530, the one or more processors 570, and/or the one or more memories 580 may display the alarm zone on a display screen. For example, in an aspect, the first stand alarm zone 440, the second stand alarm zone 450, and the third stand alarm zone 460 may be displayed on the display screen 494.

At block 1006, the controller 530, the one or more processors 570, and/or the one or more memories 580 may receive a signal indicating a completion of a security check of the aircraft. For example, in an aspect, once the first aircraft 310 is checked, a mobile guard/operator may send a signal to indicate the same.

At block 1008, the controller 530, the one or more processors 570, and/or the one or more memories 580 may indicate an armed state of the alarm zone by changing a visual characteristic of the alarm zone on the display screen. For example, in an aspect, to indicate that the first stand alarm zone 440 around the first aircraft 310 is armed, the display screen 494 may change to indicate the armed state of the first stand alarm zone 440, e.g., may change a background color of the first stand alarm zone 440 from green to red.

In one non-limiting optional example aspect, analyzing the first data and the second data at block 730 of method 700 may be performed responsive to the completion of the security check of the aircraft.

In one non-limiting optional example aspect, providing the notification at block 740 of method 700 may include displaying the notification on the display screen 494.

In one non-limiting optional example aspect, displaying the notification may include displaying a zoomed view of the one or more undesirable objects. For example, upon detecting the human 470 in the first stand alarm zone 440 which is armed, a first pop-up display area 490 may be provided on the display screen 494 to provide detailed (zoomed-in) imagery of the human 470 as captured by the cameras.

In one non-limiting optional example aspect, displaying the notification may include displaying one or more visual characteristics of the one or more undesirable objects. For example, a second pop-up display area 492 may be provided on the display screen 494 to provide textual details and visual identifiers of the human 470, such as “Security Breach Detected: Person, Blue Top, Grey Bottom.”

The system 500 and the methods 700 and 1000 effectively monitor an aircraft and generates threat alerts upon detecting potentially threatening objects proximal to an aircraft. The system 500 can be employed for each aircraft separately or can be employed to monitor multiple aircrafts simultaneously. The system 500 and the methods 700 and 1000 can be employed to monitor one or more aircrafts post completion of security check or completion of maintenance related operations in an apron area. Further, the system 500 and the methods 700 and 1000 can be employed to continuously monitor an aircraft before, during, or after maintenance work or security check is completed.

The system 500 and the methods 700 and 1000 eliminate need or intervention of a human being for monitoring an aircraft, and thus, eliminates possibility of human errors in identifying security threats to an aircraft.

### Configuration of Example Aspects

The construction and arrangement of the systems and methods as shown in the various example aspects are illustrative only. Although only a few aspects have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative aspects. Other substitutions, modifications, changes, and omissions can be made in the design, operating conditions and arrangement of the example aspects without departing from the scope of the present disclosure.

The present disclosure contemplates methods, systems and program products on any machine-readable media for accomplishing various operations. The aspects of the present disclosure can be implemented using existing computer processors, or by a special purpose computer processor for an appropriate system, incorporated for this or another purpose, or by a hardwired system. Aspects within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. An aircraft surveillance system comprising:
one or more radar sensors configured to scan an area proximal to an aircraft and provide first data corresponding to scanning of the area;
one or more cameras configured to capture visuals of the area and provide second data corresponding to captured visuals of the area; and
one or more processors in communication with the one or more radar sensors and the one or more cameras, the one or more processors, individually or in combination, configured to:
receive the first data from the one or more radar sensors and the second data from the one or more cameras;
analyze the first data and the second data to identify presence of one or more undesirable objects proximal to the aircraft; and
provide a notification upon detection of the one or more undesirable objects, wherein the notification indicates a security threat.

2. The aircraft surveillance system of claim 1, wherein to provide the notification, the one or more processors are configured to transmit one or more notification signals to one or more user devices.

3. The aircraft surveillance system of claim 1, wherein the one or more processors are further configured to receive an actuation signal from one or more data sources, wherein the one or more processors are configured to analyze the first data and the second data responsive to receiving the actuation signal.

4. The aircraft surveillance system of claim 1, wherein the notification includes information related to a location and a distance of the one or more undesirable objects with respect to the aircraft.

5. The aircraft surveillance system of claim 4, wherein to identify the presence of the one or more undesirable objects, the one or more processors are configured to determine the location and the distance of the one or more undesirable objects based on the first data.

6. The aircraft surveillance system of claim 1, wherein to identify the presence of the one or more undesirable objects, the one or more processors are configured to:
detect objects in the first data and the second data; and
identify the one or more undesirable objects within the objects based on one or more predetermined markers.

7. The aircraft surveillance system of claim 1, wherein a first radar sensor within the one or more radar sensors is configured to scan a substantially upper outer surface area of the aircraft and a second radar sensor within the one or more radar sensors is configured to scan a substantially lower outer surface area of the aircraft, wherein a first camera within the one or more cameras is configured to scan the substantially upper outer surface area of the aircraft and a second cameras within the one or more cameras is configured to scan the substantially lower outer surface area of the aircraft.

8. The aircraft surveillance system of claim 7, wherein the first radar sensor and the second radar sensor are placed proximal to a front end and a rear end of the aircraft, respectively, wherein the first camera and the second camera are placed proximal to the front end and the rear end of the aircraft, respectively.

9. The aircraft surveillance system of claim 1, wherein the one or more cameras include at least one of a high-resolution camera, a pan-tilt-zoom (PTZ) camera, a fixed camera, or an infrared camera.

10. The aircraft surveillance system of claim 1, wherein the one or more processors are configured to identify the one or more undesirable objects using at least one of an image processing technique, video analytics, and/or radar data analysis.

11. The aircraft surveillance system of claim 1, wherein the one or more processors are further configured to:
analyze the first data and/or the second data to define an alarm zone around the aircraft; and
display the alarm zone on a display screen.

12. The aircraft surveillance system of claim 11, wherein the one or more processors are further configured to:
receive a signal indicating a completion of a security check of the aircraft; and
indicate an armed state of the alarm zone by changing a visual characteristic of the alarm zone on the display screen.

13. The aircraft surveillance system of claim 12, wherein the one or more processors are configured to analyze the first data and the second data responsive to the completion of the security check of the aircraft.

14. The aircraft surveillance system of claim 13, wherein the one or more processors are configured to display the notification on the display screen.

15. The aircraft surveillance system of claim 13, wherein the one or more processors are configured to display the notification including a zoomed view of the one or more undesirable objects.

16. The aircraft surveillance system of claim 13, wherein the one or more processors are configured to display the notification including one or more visual characteristics of the one or more undesirable objects.

17. A method comprising:
receiving first data from one or more radar sensors configured to scan an area proximal to an aircraft and second data from one or more cameras configured to capture visuals of the area;
analyzing the first data and the second data to identify presence of one or more undesirable objects proximal to the aircraft; and
transmitting one or more notification signals to a user device upon detection of the one or more undesirable objects, wherein the one or more notification signals indicate a security threat.

18. The method of claim 17, further comprising determining a location and a distance of the one or more undesirable objects based on the first data.

19. The method of claim 17, wherein the one or more undesirable objects are identified based on predetermined physical or virtual markers.

20. A system comprising:
one or more processors; and
one or more memories each communicatively coupled with at least one of the one or more processors and each storing all or some portion of instructions that, when executed by the one or more processors, cause the one or more processors, individually or in any combination, to:
receive first data from one or more radar sensors configured to scan an area proximal to an aircraft and second data from one or more cameras configured to capture visuals of the area;
analyze the first data and the second data to identify presence of one or more undesirable objects proximal to the aircraft; and
transmit one or more notification signals to a user device upon detection of the one or more undesirable objects, wherein the one or more notification signals indicate a security threat.
